(19) United States
(12) Patent Application Publication
(10) Pub. No.: US 2007/0112579 A1
(43) Pub. Date: May 17, 2007

(54) Market management system

(75) Inventors: Manoj Ratnakaran, Plano, TX (US); Carl Ray Grossardt, Tulsa, OK (US); Christopher Robertson Crawford, Carrollton, TX (US)

Correspondence Address: AKIN, GUMP, STRAUSS, HAUER & FELD, 1111 LOUISIANA STREET, 44TH FLOOR, HOUSTON, TX, 77002, US

(73) Assignee: ADS Alliance Data Systems, Inc., Dallas, TX (US)

(21) Appl. No.: 11/468,821

(22) Filed: Aug. 31, 2006

Related U.S. Application Data
(60) Provisional application No. 60/713,515, filed on Sep. 1, 2005.

(51) Int. Cl. G06Q 99/00

(52) U.S. Cl. 705/1

(57) ABSTRACT

A market management system is designed to manage energy industry standardized transactions between energy providers and utility distribution customers. The system includes business process and transaction validations along with transaction tracking. The market management system processes transactions in its own data format but stores the transactions in a client's customer information system (CIS) using the CIS's data format. Using only the CIS database for transaction storage eliminates the need to synchronize transaction records in the CIS database with records in a market management database. Exception management is integrated with the CIS to eliminate duplication of effort. The market management system's functionality is scalable such that varying levels of service may be provided to customers. Predetermined business rules may be customized for the purpose of validating transactions.

### CROSS-REFERENCE TO RELATED APPLICATIONS

This application claims the benefit under 35 U.S.C. §119(e) of U.S. Provisional Patent Application No. 60/713,515, filed Sep. 1, 2005, which is incorporated herein in its entirety for all purposes.

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to the field of transaction processing and in particular to systems for processing transactions between consumers and customer information and billing systems.

2. Description of the Related Art

Today's energy industry is in various stages of restructuring. As this new environment emerges and continues to develop across the U.S., market participants face entry into new trade relationships that require the timely, accurate exchange of information, compliance with market rules, and new ways of doing business to serve the consumer.

Energy deregulation has prompted a restructuring of the industry's value chain. This restructuring has opened the door for new market entrants and modified the role of current industry participants. However, deregulation may fail to deliver on its promise of customer choice and market efficiency unless seamless, real-time, and reliable, actionable, information is achieved between all entities in the new industry value chain.

Energy Service Providers (ESPs)—who now own the account relationship with residential, commercial, and industrial customers—may represent customer demand to a variety of Utility Distribution Companies (UDCs). UDCs—who own the power distribution infrastructure—deliver power to endpoint customers (that may be served by numerous ESPs) and sustain the distribution system. Therefore, the newly deregulated marketplace imposes a “many-to-many” interaction model on and between the hundreds of existing UDCs and the burgeoning population of competitive retailers.

Industry participants must exchange a variety of complex data and transactions. ESPs and UDCs must share customer non-public personal information (NPPI), such as identification and associated profile data and must be tightly controlled. Additionally, transactions supporting service enrollment, meter reading, service orders, billing, and payments must be accurately generated, forwarded, and processed between the ESPs and UDCs.

Most ESPs and UDCs have invested significant time and money to create unique and often proprietary customer and operational support systems. Typically, these systems require special interfaces or formats to facilitate the flow of information between organizations. To further complicate matters, there is no industry standard for the identification of customers or business transactions (e.g., service enrollment, meter reading, etc.). Therefore, routing the right information to the right destination in the right format is costly and time consuming.

A clearinghouse that processes the industry's countless number of systems, transactional formats, data anomalies, and business rules is critical to overall market success. ESPs and UDCs cannot obtain economies of scale and speed-to-market without such an informational and transactional infrastructure. Comparable to a universal power distribution grid, a robust real-time clearinghouse paves the way for the multipoint distribution of data between the numerous ESPs, UDCs, and other industry participants.

The existing market management systems are typically not fully integrated into the overall company solution footprint. This lack of integration has contributed to a siloed approach for Market Management capabilities and resources and has led to a “path of least resistance” sales strategy. This means that new market management opportunities have typically been evaluated with one-off alternatives rather than a true integrated Market Management solution.

Decisions have typically been based on the path of least resistance in the hopes of garnering potential business. Although logical in the short term, this approach propagates a haphazard, unfocused strategy that can lead to long term inefficiencies—architecturally, operationally, and financially. This lack of strategic focus typically results in the creation of a host of disparate and poorly architected solutions, which further impedes the ability to gain leverageable, scaleable, and operational efficiencies.

As the various states, such as California and Texas, or specific National Electric Reliability Council power pools, such as the Pennsylvania, Jersey, Maryland, Power Pool (PJM) and the Electric Reliability Council of Texas (ERCOT), have developed approaches to deregulation of electricity and gas energy markets, each has taken a slightly different direction in creation and deployment of standard electronic messaging schemes to allow the various market participants to exchange information. These messages are commonly referred to as “transactions.” These transactions are used to convey virtually all required information among market participants.

In order to conduct business in any of these markets, regardless of the market role of each specific party, each must have the capability not only to interpret the contents of the individual messages but to implement business logic driven actions based on the type and content of each of the various transactions. Although attempts have been made to standardize these messaging schemes within each “market,” no national “market model” has been adopted and, consequently, no national data exchange messaging scheme standard has been adopted and put into practice. The majority of schemes currently in use are based roughly on Electronic Data Interchange standards as adopted by the American National Standards Institute, such as X12 or similar standards for Electronic Data Interchange.

Depending on the specific “market model,” these transactions are typically organized into transaction families, which are used to accomplish generalized groups of tasks or to convey information relating to general business practices. As these standard transactions have been adopted for use in the electrical energy industry, transaction families have evolved and been organized into numbered family groups or “sets” such as the 814 family of transactions. The 814 family of transactions are used to manage information regarding the relationship between a specific service delivery point and a consumer that is being served at that location, as well as any details about either the service delivery point or the consumer. The 814 family of transactions typically include enrollments, drops, reinstatements and changes in details about the service delivery point or the consumer. Likewise, there are other transaction families, which are used to form electronic invoices (810 transaction set), receiving reports (867 transaction set), service orders (650 transaction set), etc., that are widely used although with some differences in construction and function. The 810 transaction set typically includes total amount due, measurement values, rate being charged on the account, prorated charges, service order charges, and a description of the charges. The 867 transaction set typically includes the type of reading being sent (initial, total consumption history, or periodic), and sometimes due date and time. The 650 transaction set typically includes information specific to the different types of service orders that may take place at the service delivery point such as requests, cancels, and changes/updates. The 824 transaction set typically includes information regarding a rejection of either an 867 or an 810 transaction. The 820 transaction set typically includes detailed information regarding a payment specific to an 810 invoice, such as payment method, date, related 810 tracking number, invoice amount, and other general payment information. In composite, these transaction sets are used to manage the wholesale and retail commodity purchases and sales, as well as delivery and end customer service provisioning to operate all aspects of each market. Each market typically uses transaction sets that are at least slightly different from those in other markets. These differences create the problem for anyone wanting to participate in multiple markets that each market typically requires that specific actions occur based on the content of these transactions to accomplish identical functions. There is a need for a product that can manage the transactions in multiple markets.

A second need is to allow the use of any chosen customer care and billing application. All existing customer information and billing systems (CIS systems) were developed to perform the same general business functions, however, each specific application has typically been constructed and deployed to accomplish these functions in slightly different ways. This in turn typically requires that the information from the market to perform these tasks be presented to the CIS in slightly different ways and with slight differences in the detail of the data delivered.

Therefore each CIS requires at least slightly different methods of delivery and content of the data, which is difficult to achieve with conventional systems.

A third need is to perform many of the required data validations. Data that is typically stored within the CIS is used for referential checks. The data from each transaction is validated using prescribed business rules. If all validations are passed, the transaction data is sent from the market management system to the customer information interface to be loaded to the CIS database. The lack of coupling between the CIS and the market management system has typically required storage of the data in duplicate databases. This duplicate storage has driven up the expense of the storage infrastructure required to support the operation of the conventional applications. Duplicate storage, along with use of each of the stored copies of the data by the parent computer application, can also cause instances where the data that is intended to be identical becomes corrupted and no longer in synchrony.

Various computer applications have been developed to allow market participants or their service providers to interpret or translate the standard EDI transactions into a standard format. Numerous service providers, such as Excelergy Business Runner, EC Power and ExoTran, offer this service. These translation service providers have not offered a comprehensive business rules engine as a component of that service to perform the necessary validations of data content of the transactions or trigger the appropriate action based on the transaction content. In many cases, the CIS developer has added extended functionality to accommodate meeting these requirements. This has led to specific solutions being developed that are unique to that particular CIS and has resulted in many approaches/solutions being developed that lack the portability to be readily modified for use with other CIS designs.

In other cases, a stand alone application has been constructed to manage the performance of these business rule validations outside of the CIS. These applications have been designed and deployed in a manner that requires multiple copies of each individual transaction to be stored. One copy is typically placed in storage outside of the CIS to support the performance of validations and another copy has typically been stored within the CIS database. The requirement of storing multiple copies of transactions as well as multiple instances of individual data elements from within each transaction has been driven by the loose coupling between the transaction business rule validation engine and the CIS. In attempts to compensate for this lack of a close coupling, data from the CIS is often ported back into the transaction management application to allow for referential business rule validations, which even further increases the need for duplication of data storage. Subsequently, the need to develop and routinely perform tedious reconciliation activities to insure data synchrony is conventionally paramount for maintaining a high quality processing standard.

### BRIEF SUMMARY OF THE INVENTION

The market management system has been designed to be easily configurable to perform transaction management and message processing from multiple markets to one CIS instance. The market management system has been designed to be easily adaptable to multiple CIS systems regardless of energy market. The market management system has been designed to allow for reduced transaction storage requirements by using a shared database with the CIS. The market management system provides a high degree of processing quality by sharing a common database instance thus removing the need for any reconciliation to maintain synchronicity between the two databases.

The market management system has been designed to use an intrinsic adaptor layer interface to interact with any CIS application program interface. This feature allows for ease of interaction with multiple CIS products with minimum of configurations to allow overcoming issues surrounding interfacing individual vendor products that each use internal proprietary formats.

The market management system has been designed to be easily configurable using an internal XML (extensible markup language) format creating a unique ability to perform transaction management and message processing from multiple markets to one CIS instance. This allows for independent validation layering to easily insert unique business rule validation criteria for multiple markets and CIS as well as unique interpretation of business rules by individual system installation (unique per client).

Since the CIS does not store market transaction data, the market management system stores summary data in tables internal to the market management system. For all customer data stored in the CIS, market management system utilizes the CIS API (application program interface) to get to that data wherever possible.

This new solution is the industry's only solution that meets the business integration challenges mentioned above. Reliable, robust, and extensible, the Market Management System (MMS) harnesses the power of the Internet to level the playing field in the deregulated electric and natural gas industries. By eliminating the hurdles and distractions of how to communicate vital customer and transaction information, the MMS enables UDCs and ESPs to focus their attention on the things that will help attract and retain customers—lower costs and improved customer service.

In one embodiment, a company can offer 3 levels of service to the market: Translation Services, Fully Outsourced Transaction. Life Cycle Management, and Customer Managed. The MMS routes transactions correctly and validates the information sent and received for usability. The MMS handles all formats, including Electronic Data Interchange (EDI), Extensible Markup Language (XML), and flat files. It manages file conversion. It even identifies exceptions that may occur before the information is delivered to the recipient. The MMS operates in near real time, eliminating delays that could affect customer service and cash flow. As a hosted application in some embodiments, nothing more of the client is required than a standard web browser to leverage the power of the MMS; no special software, expensive computers, or communications equipment is needed. This translates into lower implementation costs and faster implementation times. It also means no long term maintenance costs usually associated with the introduction of new hardware or software.

### BRIEF DESCRIPTION OF THE DRAWINGS

FIG. 1 illustrates the relationships between various elements of a market management system according to one embodiment;

FIG. 2 illustrates the scope of functionality within an embodiment of a market management system;

FIG. 3 illustrates the interaction of the major components in some embodiments of a market management system;

FIG. 4 is a flow chart illustrating the general architecture for inbound transaction processing according to one embodiment;

FIG. 5 is a flow diagram illustrating the general architecture for outbound transaction processing according to one embodiment;

FIG. 6 is a data flow diagram illustrating the operation of a CIS API Wrapper according to one embodiment;

FIG. 7 is a data flow diagram illustrating the operation of a CIS Response Processor according to one embodiment;

FIG. 8 is a data flow diagram illustrating the operation of an ERCOT 727 Data Processor according to one embodiment;

FIG. 9 and FIG. 10 are flow diagrams illustrating the 820 transaction process according to one embodiment;

FIG. 11 is a data flow diagram illustrating processing 824 transactions according to one embodiment;

FIG. 12 is a data flow diagram illustrating the transaction resubmit processor according to one embodiment;

FIG. 13 is a flow diagram illustrating file and transaction logging for a typical inbound transaction;

FIG. 14 is a flow diagram illustrating file and transaction logging for a typical outbound transaction;

FIG. 15 is a flow diagram illustrating 997 tracking information;

FIG. 16 is a flow diagram illustrating assembling outbound enrollment and customer maintenance transactions;

FIG. 17 is a flow diagram illustrating assembling outbound service order transactions; and

FIG. 18 is a diagram illustrating system interfaces for some embodiments of the market management system.

### DETAILED DESCRIPTION OF THE INVENTION

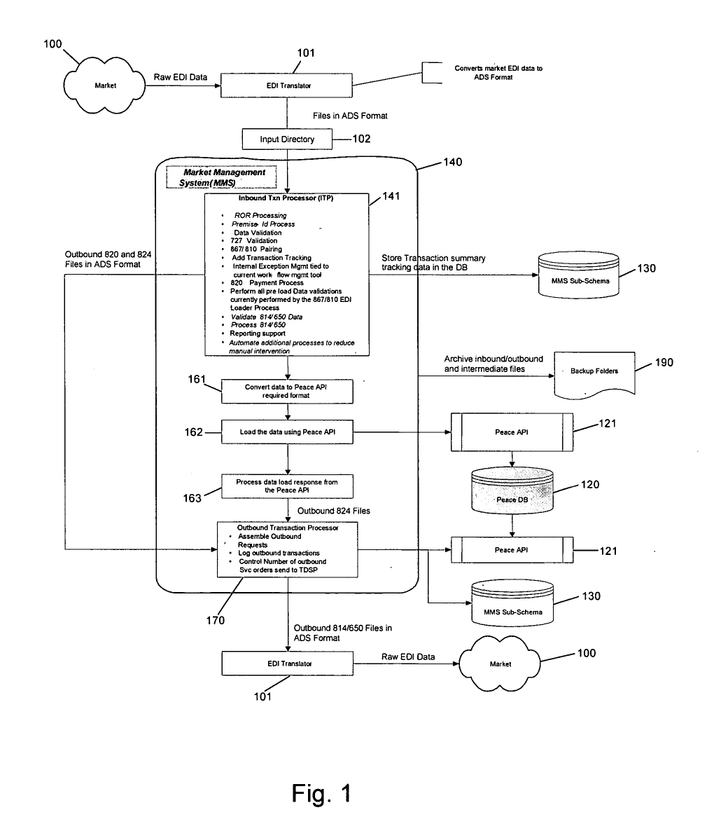

A market management system as disclosed herein reduces the complexity of market transactions and facilitates easy access and sharing of information among providers—a solution that is unparalleled in the marketplace in functionality, service, and value. FIG. 1 illustrates one embodiment of the market management system (MMS) 140 that replaces the functionality of a customer's preexisting transaction processing, such that all transaction validation and tracking is performed by the MMS 140. Starting with data from the market 100, the data is translated by the EDI translator 101 into an MMS format, which is stored in input directory 102. The MMS format is independent of the data format used by the market 100. The formatted data is accessed by the MMS 140 from the input directory 102. The MMS 140, in this embodiment, is comprised of an inbound transaction processor 141, outbound transaction processor 170, a data converter 161 to convert the data from the MMS format to the format for a CIS, a data loader 162, and a response loader 163. Although the following description refers to the Peace CIS, Peace is illustrative and exemplary only and other CISs can be used. The format for the CIS is independent of the MMS format and the format used by market 100. In the following, the MMS is described as processing transactions as defined by ERCOT. However, these transaction types and families of transactions are illustrative and exemplary only, and other transactions and families of transactions can be used.

Transactions that enter the MMS 140 are archived in backup folders 190 along with outbound files and intermediate files processed by the MMS 140. Summaries and tracking records of the transactions that enter the inbound transaction processor 141 are stored in the MMS database 130.

After a transaction is validated in the inbound transaction processor 141, the transaction format is converted by the data converter 161 to a data format required by the Peace API 121. Converted transactions are then loaded by the data loader 162, which loads the transaction data through the Peace API 121 into the Peace Database 120. Response data from the Peace Database 120 passes through the Peace API 121 and is loaded by the response loader 163 into the market management system 140. The response loader 163 converts the data format from the format used by the Peace API 121 to the MMS format. Failure reports, typically called 824 transactions, are sent to the outbound transaction processor 170, which also receives failure reports from the inbound transaction processor 141. The outbound transaction processor 170 assembles outbound requests and logs outbound transactions. Status update information is passed from the outbound transaction processor 170 to the Peace API 121 and MMS database 130. This status update information is related to the transmission of the staged outbound request back into the Peace CIS for providing request status to the user. The outbound transaction processor 170 sends 814 transactions and 650 transactions to the EDI translator 101, which converts the data format from the market management system format back to the market 100 format.

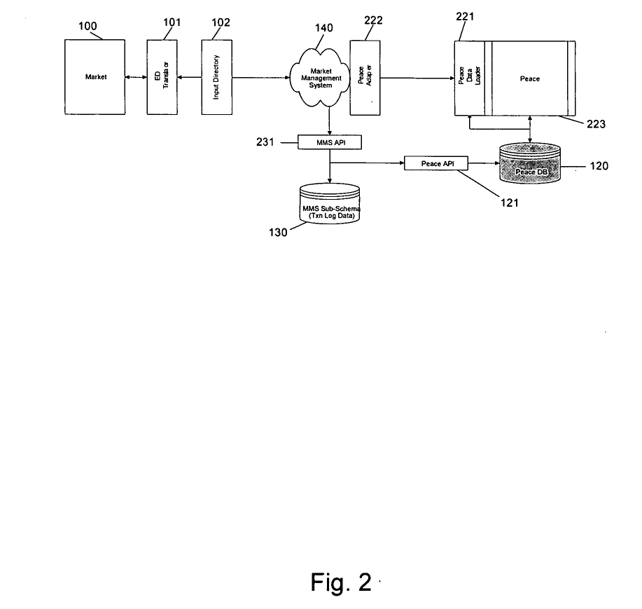

FIG. 2 illustrates the scope of functionality within one embodiment of the market management system 140 at a high level. In one embodiment, EDI data from the market 100 is converted to an MMS format by an EDI translator 101 external to the market management system 140. The formatted data from the EDI translator 101 is stored in input directory 102. If the data from the EDI translator 101 needs to go over a non-market management system provider network, then data can be encrypted for transmission. Encryption is performed using an encryption software, such as PGP software. From the input directory 102, the market management system 140 requests data. The Peace adapter 222 converts the market management system data from MMS format to Peace API format. The formatted data are then loaded into the Peace application 223 through the Peace data loader 221. Data from the market management system 140 are loaded in the MMS API 231, which directs most of the transactional validation data to a local MMS database 130 which stores local data for most transaction validations. The MMS API 231 directs the customer data and some transactional validation data to the Peace API 121, which moves the data to the Peace database 120.

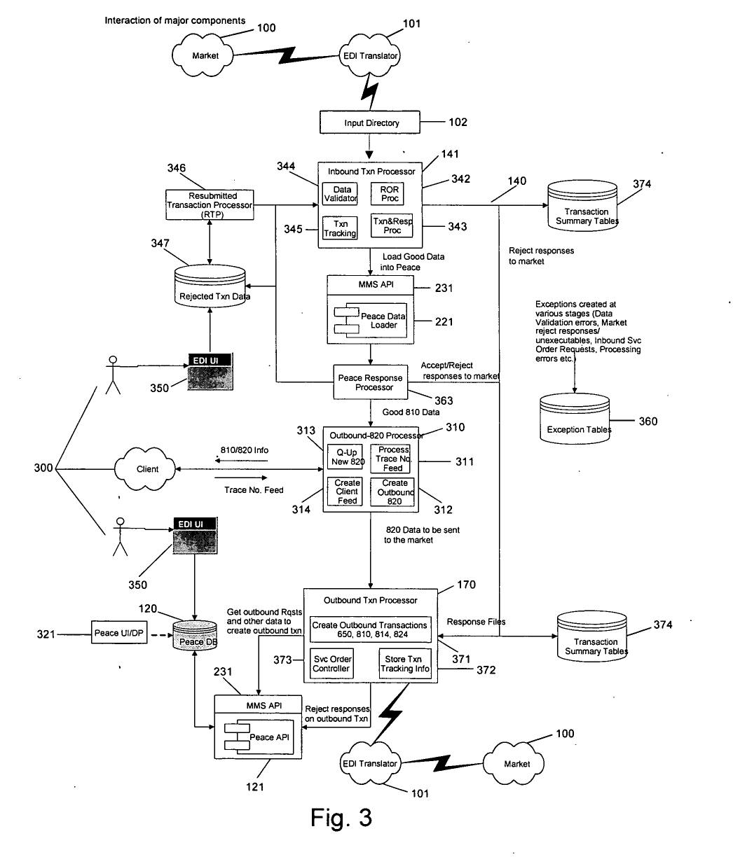

FIG. 3 shows the interaction of the major components in some embodiments of the market management system 140. Data obtained from the market 100 and converted to MMS format by the EDI translator 101 are stored in the input directory 102 until accessed by the inbound transaction processor 141. The inbound transaction processor is a group of validation modules, transaction modules, and processing routines comprising a Rep of Record (ROR) processor 342, Transaction and Response processor 343, data validator 344, and transaction tracking module 345. Validations include structural conformance with market guidelines, ROR checking, 727 data validation and other referential checks. Summaries of the transactions are stored in the transaction summary tables 374. Data that have been validated are loaded by way of the MMS API 231, which may access data through the Peace data loader 221 or other data access mechanisms. Data received back from the Peace Database 120 in the form of a results file containing the status of each transaction to indicate whether loading was successful or not are received by the Peace response processor 363. Valid 810 data, such as invoices, are sent to the outbound-820 processor 310.

The outbound-820 processor is comprised of a series of modules to process trace number feed 311, create outbound 820 data 312, Queue up new 820 data 313, and create client feed 314. The 820 processor takes care of creating 820 payment transactions in response to the Transmission and/or Distribution Service Provider (TDSP) 810 invoices (accepted 810s), creating client feeds containing the 820 summary data, making sure that total payment amount on a particular transaction is not negative and controlling the number of payment records within a transaction. The 810/820 information is sent from the outbound 820 processor 310 to the client 300, and the client 300 sends trace number feed data, such as for a banking payment transaction, to the process trace number feed module 311. After 820 data is prepared by the create outbound 820 module 312, the 820 data is sent to the outbound transaction processor 170.

The outbound transaction processor 170 is comprised of a create outbound transactions (types 650, 810, 814, 824) module 371, a store transaction tracking information module 372, and a service order controller 373. Reject responses from the inbound transaction processor 141 are directed to the create outbound transactions module 371 for delivery to the market 100. Outbound transactions are sent to the EDI translator 101 for format conversion prior to delivery to the market 100. Information required to create an outbound transaction is requested by the outbound transaction processor 170 from the Peace database 120 through the MMS API 231 and Peace API 121 combination. Reject responses are then returned to the Peace database 120 via a similar communication process. Some transactions can enter the Peace database 120 through generation by the Peace user interface or data processing module 321. These can include system generated (e.g. collection-driven 650 requests) or user-initiated market requests (e.g. 814 change requests). The client 300 may also load information into the Peace database 120 by way of the EDI user interface 350. This EDI user interface 350 allows correcting and marking rejected transactions for resubmission and can send or receive data from a rejected transaction database 347, where the Peace response processor 363 sends rejected transactions that can be marked for either auto or manual resubmission. The EDI user interface 350 creates Application advice (824) requests for rejected transactions that were queued for manual review. Rejected transactions are also sent to a resubmitted transaction processor 346. The resubmission process puts the rejected transactions that were marked for resubmission into new files for getting reprocessed by the inbound transaction processor 141. Exceptions created throughout the market management system processes are stored in exception tables 360.

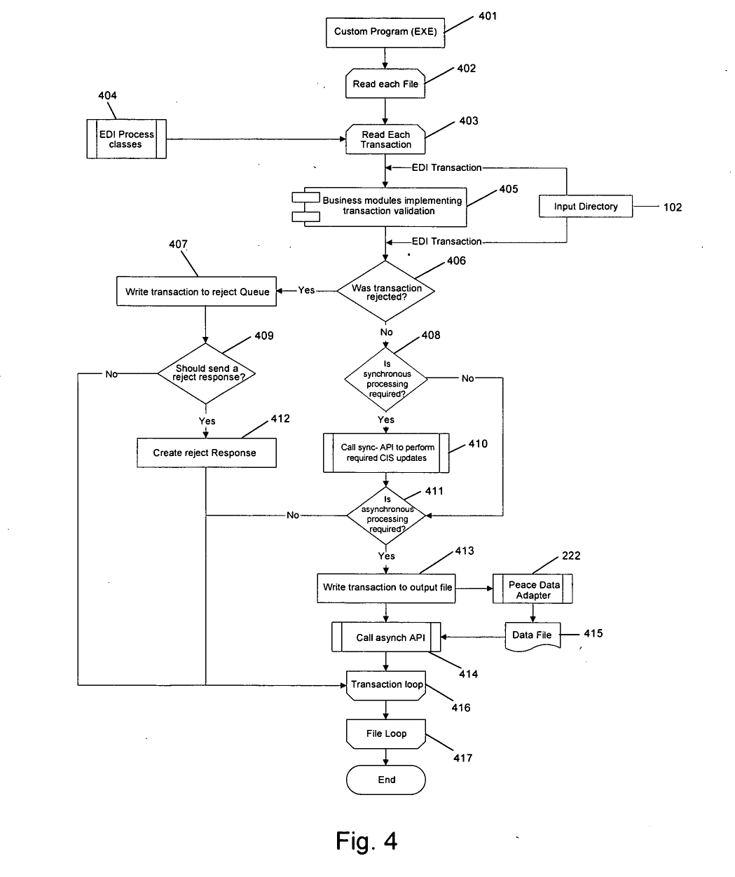

FIG. 4 is a flow chart illustrating inbound transaction processing according to one embodiment. A custom program 401 reads a data file in a loop beginning at 402. Custom program 401 serves as the input interface to receive multiple input formats and convert the multiple input formats to a standard internal XML format. EDI process classes are supplied in block 404 and each transaction is read from the file in a loop beginning at block 403. When a transaction is read in block 403, EDI transaction data are fetched from the input directory 102 for validation. The transactions are then validated by business module in block 405. After validation, the EDI transaction data are again fetched from the input directory 102 for processing. At a transaction rejection decision point 406, the transactions are directed to either block 407 for writing a transaction to the reject queue or to block 408 to establish whether synchronous or asynchronous processing is required.

If the transaction is rejected and written to the reject queue, a decision is made about sending a reject response in block 409. If no reject response is to be sent, the transaction loop finishes at block 416, causing the next transaction to be processed. If a reject response is to be sent, then the create reject response 412 block creates the reject response before the transaction loop finishes in block 416.

If the transaction is not rejected, then the synchronous processing requirement check 408 is performed. If synchronous processing is not required, then a check is made for asynchronous processing being required in block 411. If asynchronous processing is not required, then the transaction proceeds to the end of the transaction loop 416. If asynchronous processing is required, then the transaction is written to an output file in block 413 and the output is sent to the Peace data adapter 222 and an asynch API 414 is called. The Peace data adapter 222 records the transaction in a data file 415. The data file 415 is directed to the asynch API 414, and then the transaction loop ends in block 416. The transaction loop then processes the next transaction beginning with block 403. After all transactions for a file have been processed, the file loop processes the next file beginning in block 402. When all files have been processed, the file loop ends in block 417 and the inbound process is complete.

If synchronous processing is required, then a synchronous API is called to perform the required CIS updates 410, and then the transaction proceeds through the asynchronous processing decision step 411 as above.

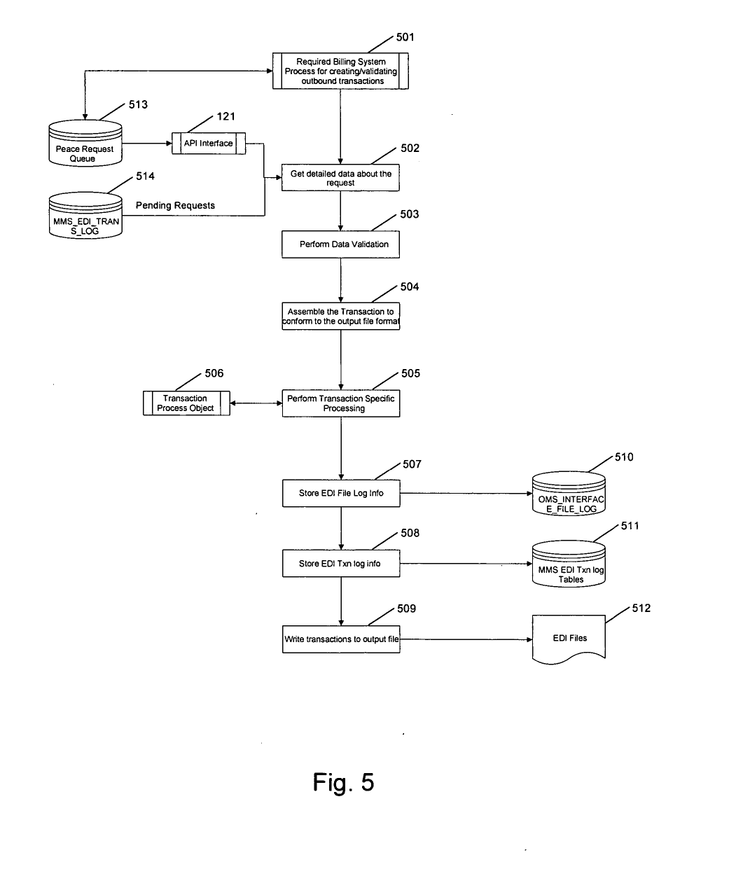

FIG. 5 is a flow chart illustrating outbound transaction processing according to one embodiment. A transaction is created by a billing system process block 501, which bi-directionally interacts with the Peace Request Queue 513. Requests from the Peace Request Queue 513 are converted into MMS Format by the API Interface 121. Additionally, pending requests from the MMS_EDI_TRANS_LOG 514 join these requests and combine with data from the billing system at the Get detailed data about the request block 502. Data validation is performed at block 503. Once validated, the transaction is assembled to conform with the output file format in block 504. Then transaction type specific processing takes place in block 505 when Transaction Process Object 506 information is introduced. Now that the transaction specific formatting is complete, the transaction's file information is stored by block 507 in the OMS_INTERFACE_FILE_LOG 510. The transaction itself is logged by block 508 in the MMS EDI Txn log Tables 511. Finally, the transaction is written by block 509 in the EDI output files 512.

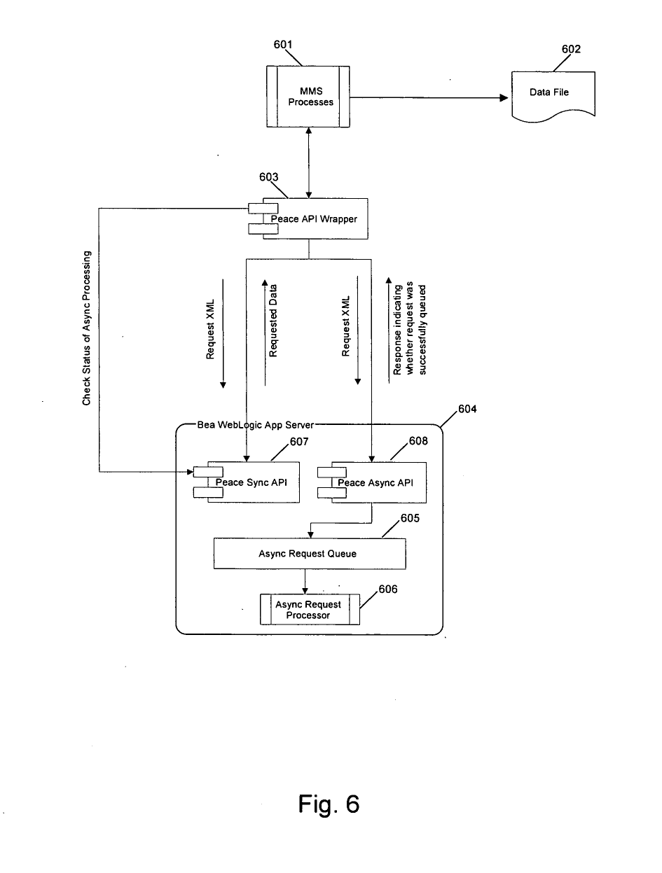

FIG. 6 is a data flow diagram illustrating system interactions according to one embodiment with the CIS API Wrapper, shown in FIG. 6 as a Peace API wrapper object 603. In one embodiment, the Peace API Wrapper 603 is a Java class that acts as an interface to the Peace API calls. The purpose of this class is to hide all the details behind connecting to the Enterprise Java Beans and invoking the synchronous and asynchronous API methods. The Peace API Wrapper 603 interacts bi-directionally with the MMS Processes 601. Data retrieval, data load and status requests are sent by the MMS processes to the wrapper object 603. For synchronous API calls, the wrapper object 603 returns back data if the call was successful. For asynchronous calls, the wrapper object 603 can either wait for the operation to be completed or return back to the MMS processes 601 a result indicating if the request was queued successfully.

The CIS API Wrapper 603 in one embodiment sends data requests and receives data from a Bea WebLogic App Server 604, which is comprised of a Peace Sync API 607, a Peace Async API 608, an Async Request Queue 605, and an Async Request Processor 606. When a synchronous data request is made, the Peace API Wrapper 603 sends a data request, in the embodiment of FIG. 6 using an XML file, to the Peace Sync API 607, which will return the requested data to the Peace API Wrapper 603. The Peace API Wrapper 603 also checks the status of asynchronous processing. When an asynchronous data load is requested, the Peace API Wrapper 603 sends a data request to the Peace Async API 608, which put the request in the Async Request Queue 605. The request resides in the Async Request Queue 605 until it is processed by the Async Request Processor 606. The Peace Async API 608 responds to the Peace API wrapper 603 indicating the request has been successfully queued.

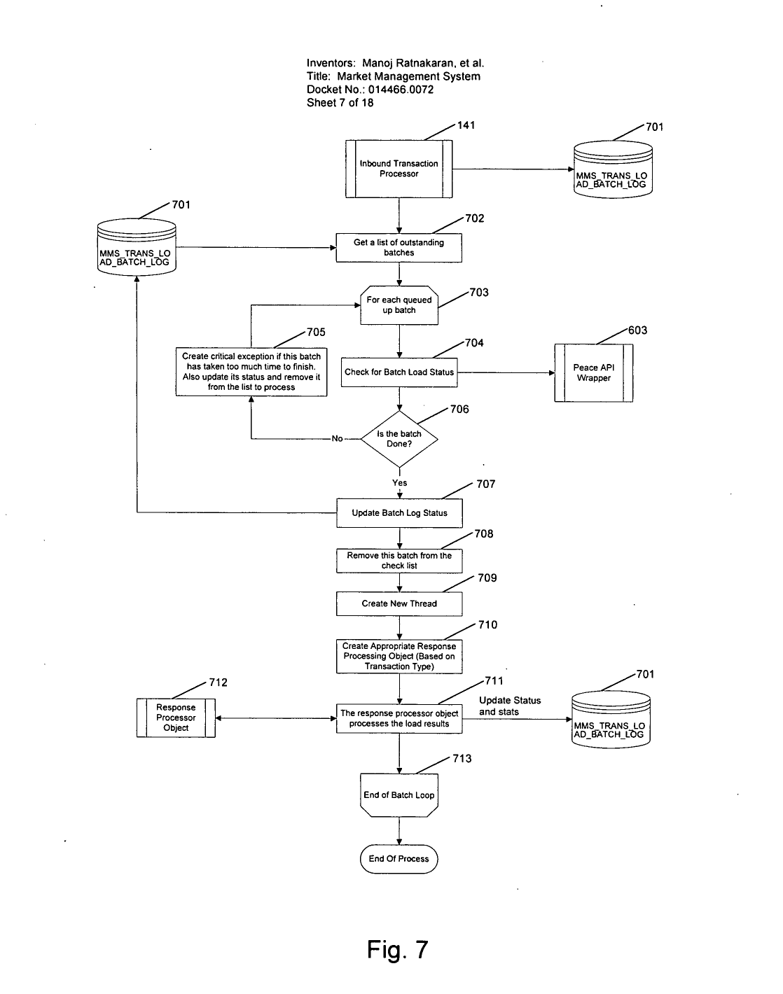

FIG. 7 is a flow chart illustrating the operation of the Peace Response Processor 363 of FIG. 3. When transactions of a batch pass validation through the inbound transaction processor 141, the transactions are then set up for presentation to the CIS. The transactions being sent are logged or recorded in the MMS_TRANS_LOAD_BATCH_LOG 701. Block 702 contains a list of outstanding batches from the log file 701. The process then loops through each queued batch, beginning in block 703. The batch load status is checked 704 and the batch of transactions is sent to the Peace API Wrapper 603 for processing as in FIG. 6. In block 706, if the batch is incomplete, it is passed back to block 703 for continued processing. But in block 705, if a batch has executed a predetermined maximum processing time, a critical exception is guaranteed and the batch is removed from the list of batches to process. If the batch is done, block 707 updates the batch log status in the MMS_TRANS_LOAD_BATCH_LOG 701, and the batch is removed from the checklist in block 708. A new thread is created in block 709, and a new response object is created in block 710, based on the transaction type. With input from the Response Processor Object 712, the load results are processed in block 711. Status and statistics for the batch processing are sent to the MMS_TRANS_LOAD_BATCH_LOG 701 by block 711, if more batches remain, the batch loop begins processing the next batch in block 703, otherwise the loop ends in block 713.

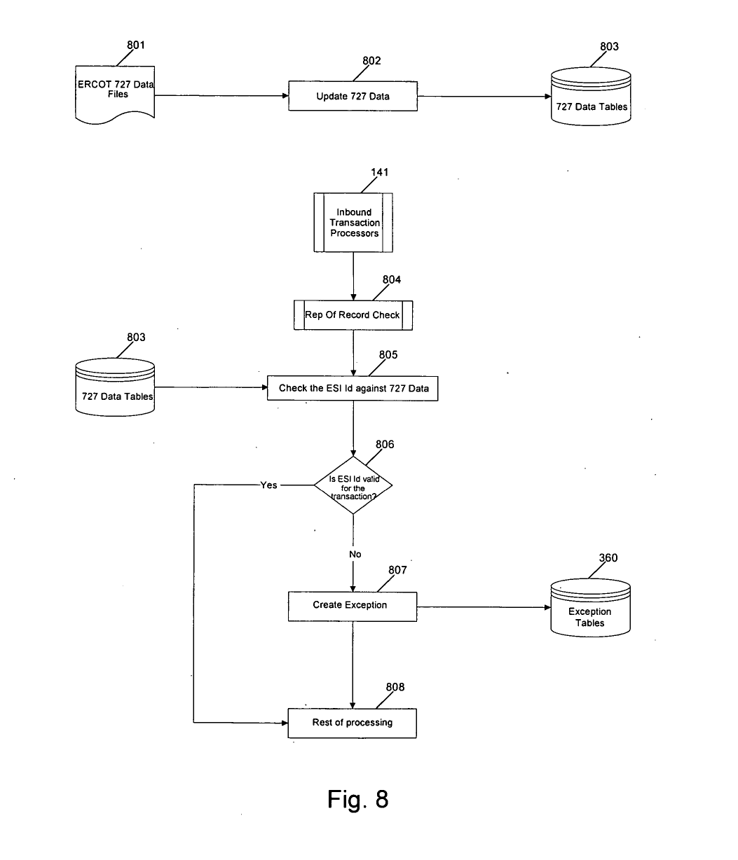

FIG. 8 shows the flow chart of the processing of an electrical energy industry standardized list (ERCOT's 727 list in this instance) that shows full service history for each ESI Id (premises where electricity is used) for which the client is the Rep of Record. ERCOT 727 Data files 801 are input to block 802, which updates the 727 data tables 803. The inbound transaction processor 141 calls for a Rep of Record check block or module 804. Block 805 verifies the ESI Id in the transaction against the 727 Data 805, which is obtained from the 727 data tables 803. If the ESI Id is valid for the transaction in block 806, then the rest of processing takes place as indicated in block 808. If the ESI Id is not valid for the transaction, then an exception is created in block 807 and stored in exception tables 360 before the rest of processing of block 808 takes place. An exception may be created, not only due to failure of Rep of Record validation, but because the transaction is not valid for the data ranges specified in the service location history or other deficiencies. Other deficiencies may include premises information that indicates that the service delivery point is not energized or disconnected or that the meter has been removed and that the delivery point is no longer viable and was removed from the list of delivery points available to be energized. These deficiencies are illustrative and exemplary only and other deficiencies can be defined to create exceptions as desired. The rest of processing depends on previous validations of the transaction data.

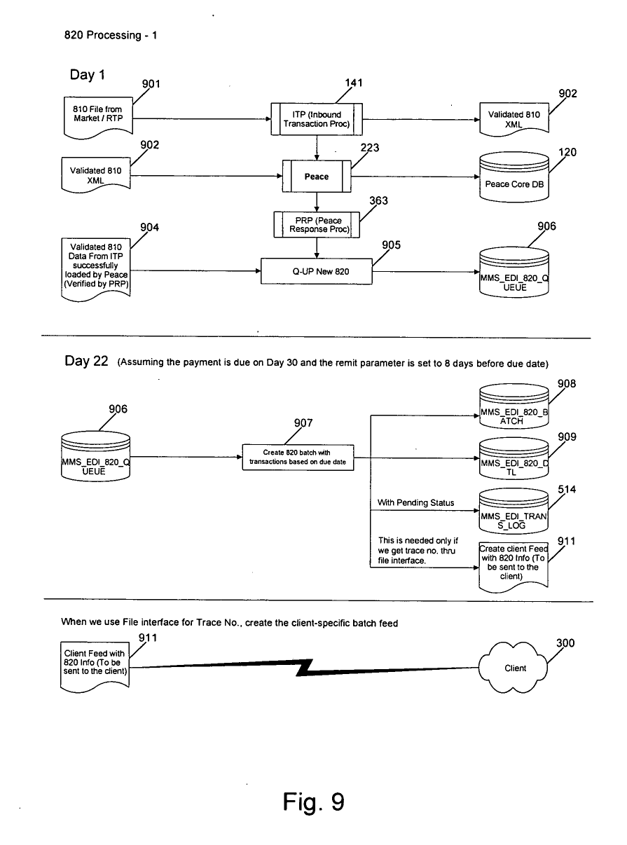

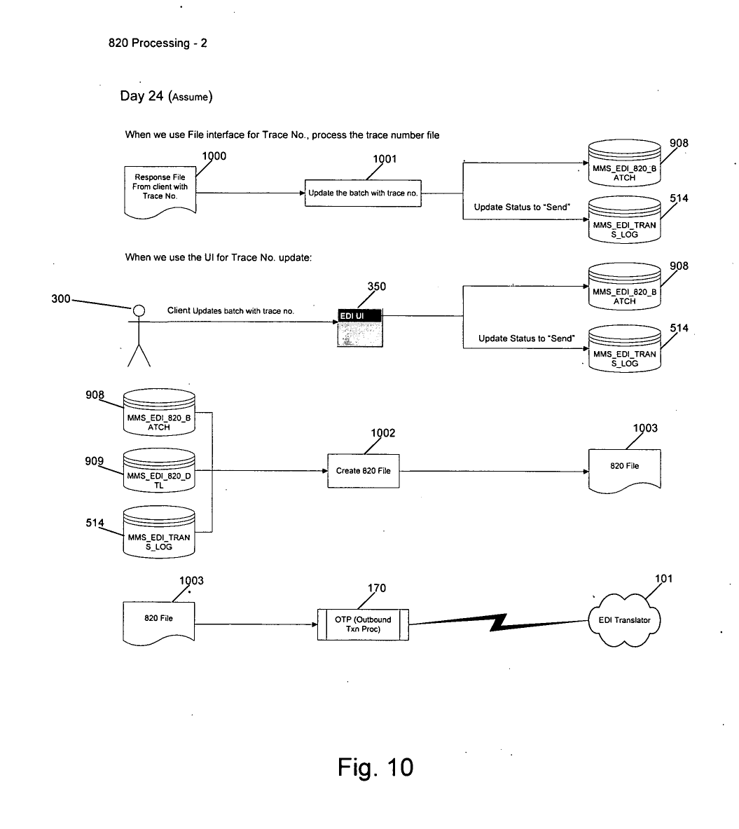

FIG. 9 and FIG. 10 illustrate the processing of incoming valid 810 transactions and the generation of their outbound 820 transaction counterparts. On Day 1, an 810 file 901 from a market or the RTP (Resubmit Transaction Processor) 346 enters the inbound transaction processor 141 and is directed to the Peace application 223. Use of the RTP 346 allows for manual correction of an internal transaction data error and resubmitting the transaction to be validated and loaded to the CIS system. A validated 810 XML file 902 records the transaction sent to the inbound transaction processor 141, and the validated 810 XML 902 is submitted to the Peace application 223. The Peace application stores the transaction information in the Peace Core database 120, and then generates a response by the Peace Response Process 363, which generates a new 820 request. Block 905 queues the new 820 request in the combination Validated 810 data from the inbound transaction processor 904 that was successfully loaded by the Peace process 223. The queued up response is stored in the MMS_EDI_820_QUEUE 906. In this example, the payment corresponding to the 810 transaction is due on Day 30 and a remit parameters is set to eight days before the due date.

On Day 22, the request leaves the MMS_EDI_820_QUEUE 906 so that a 820 batch may be created based on its due date in block 907. Records that make this transaction negative are not selected, but an exception is generated if a record stays in the queue for more than “x” number of days past its pick-up date. The 820 batch is sent to the MMS_EDI_820_BATCH file 908, MMS_EDI_820_DTL file 909, and MMS_EDI_TRANS_LOG file 514. The 820 batch is given pending status in the MMS_EDI_TRANS_LOG file 514. In an embodiment in which trace numbers are communicated through a file interface, a client-specific batch feed file 911 is created with the 820 transaction information and sent to the client 300. In the 30 day example, on Day 24 the trace number is updated. In the file interface embodiment, a response file 1000 is received from the client with a trace number. In block 1001, the batch is updated with the trace number from the file 1000, updating the MMS_EDI_820_BATCH file 908 and updating the status of the batch to “send” in the MMS_EDI_TRANS_LOG file 514.

In another embodiment, client 300 uses the user interface (UI) 350 for trace number updates. The UI 350 then updates the MMS_EDI_820_BATCH file 908 with the trace number and updates the status of the batch to “send” in the MMS_EDI_TRANS_LOG file 514. Data from the MMS_EDI_820_BATCH file 908, MMS_EDI_820_DTL file 909, and MMS_EDI_TRANS_LOG file 574 is used to create an 820 file in block 1002, creating an 820 File 1003. The 820 file 1003 is sent to the outbound transaction processor 170, which sends the 820 file 1003 to the EDI translator 101.

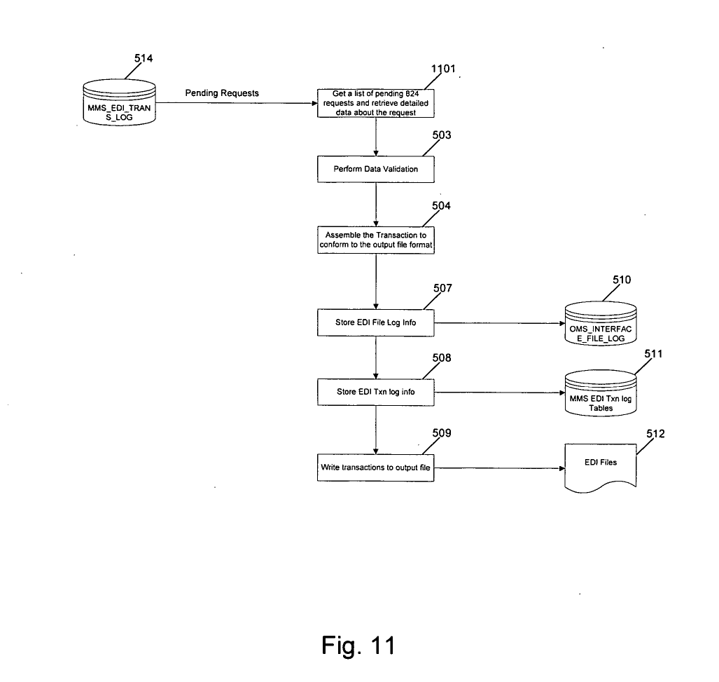

FIG. 11 is a flow diagram illustrating the generation of outbound 824 transactions. The 824 transactions are sent out to the market as a response to invalid 867 and 810 transactions. The 824 requests are triggered either automatically or as a result of manual review. The outbound 824 processor will gather all the requests and create corresponding transactions to be sent out to the market. Pending requests from the MMS_EDI_TRANS_LOG file 514 are used to make a list of pending 824 requests 1101 for retrieving detailed data about each request. Data validation is performed in block 503 on the requests, and the transaction is assembled to conform with the output file format in block 504. Once the transaction is in the correct output file format, the transaction's file information is logged in block 507 in the OMS_INTERFACE_FILE_LOG 510. The transaction is logged in block 508 into the MMS EDI Txn log Tables 511. Finally, the transaction is written to an output EDI 512 file in block 509.

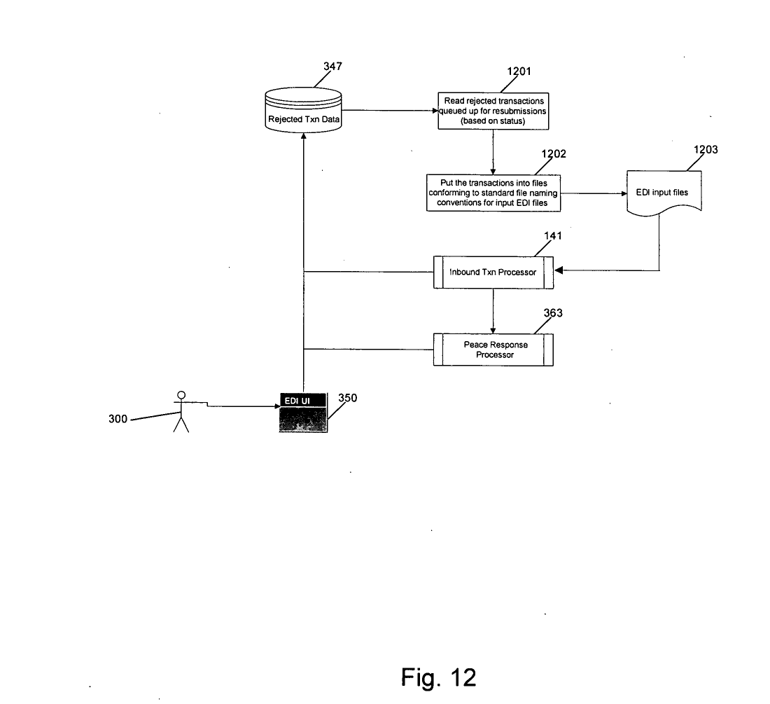

FIG. 12 is a flow chart illustrating the transaction resubmission process according to one embodiment. Transactions that fail validations are put into a resubmit queue, allowing users to view the transaction and resubmit it if necessary. A batch program can also queue up a transaction to be auto-resubmitted after a particular date. Additionally auto-reprocessing can be dependent on other trigger transactions, depending on the transaction and the reason for rejection. If applicable, the process that rejects a particular transaction can also specify the trigger transaction types which could make this transaction valid. The resubmit processor will check for any trigger transactions and if present (they should have come in after the rejected transaction was processed), this transaction is submitted for reprocessing.

The client 300 views the transactions and corrects and marks the transactions for resubmission in the EDI UI 350, which updates the Rejected Txn Data file 347. The rejected transactions are read and queued up for resubmissions based on status in block 1201. For auto-resubmittable transactions, look at the Auto_Review_Dt also. Certain transactions may depend on other trigger transactions as well. The transactions are stored in EDI input files 1203 with standard naming conventions for input EDI files in block 1202 and submitted to the inbound transaction processor 141. The inbound transaction processor 141 then sends the transactions to the Peace Response Processor 363.

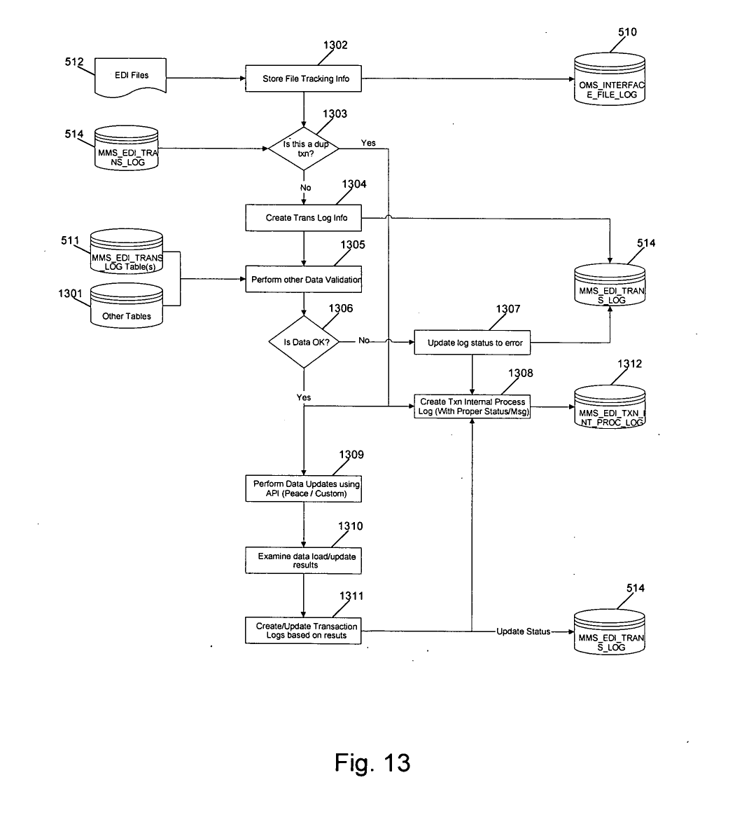

FIG. 13 is a flow chart illustrating file/transaction logging for an inbound transaction. EDI files 512 have their tracking information stored in block 1302 in the OMS_INTERFACE_FILE_LOG 510. The file tracking information is compared for duplication in block 1303 against MMS_EDI_TRANS_LOG 514. If the transaction is a duplicate, a transaction internal process log is created in block 1308 and recorded in MMS_EDI_TXN_INT_PROC_LOG file 1312. If the transaction is not a duplicate, then transaction log information is created in block 1304 and recorded in the MMS_EDI_TRANS_LOG file 514. The transaction is then validated in block 1305 against data from MMS_EDI_TRANS_LOG Table(s) 511 and Other tables 1301. Cross reference numbers are among the kinds of data that can be checked for validating in block 1305. If the data is valid in block 1306, then data updates are performed using the Peace API 1309. In addition, a transaction internal process log is created in block 1308 and recorded in MMS_EDI_TXN_INT_PROC_LOG file 1312. The data update results are examined in block 1310, and a log for the transaction is created or updated in MMS_EDI_TRANS_LOG file 514 on the results in block 1311. A transaction internal process log is also created in block 1308 in the MMS_EDI_TXN_INT_PROC_LOG file 1312. If the data is not valid in block 1306, then the log status is updated to reflect the error in block 1307 and stored in the MMS_EDI_TRANS_LOG file 514. A transaction internal process log is also created in block 1308 and recorded in the MMS_EDI_TXN_INT_PROC_LOG file 1312.

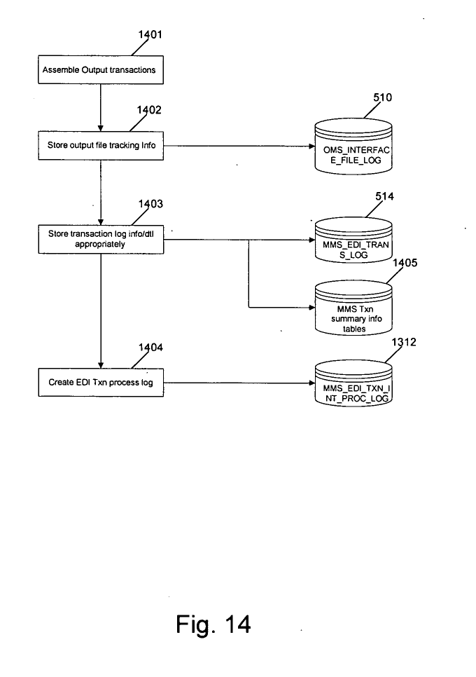

FIG. 14 is the flow chart illustrating file/transaction logging for outbound transactions. Output transactions are assembled in block 1401, and then the output file tracking information is stored in block 1402 in the OMS_INTERFACE_FILE_LOG file 510. The transaction log information details, such as individual unique transaction identification numbers, date and time of creation are stored in block 1403 in MMS_EDI_TRANS_LOG file 514 and MMS Txn summary info tables 1405. The transaction log information details listed above are illustrative and exemplary only and other transaction log information details can be used and stored. Finally, an EDI transaction process log is created in block 1404 and stored in MMS_EDI_TXN_INT_PROC_LOG file 1312.

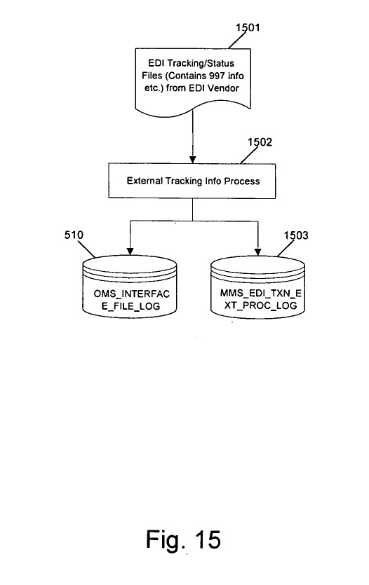

FIG. 15 is a data flow diagram illustrating storing external tracking information. The EDI Tracking/Status files 1501 from an EDI vendor, which contain 997 transaction information among other data are processed by the External Tracking Info Process 1502, and the results are stored in OMS_INTERFACE_FILE_LOG file 510 and MMS_EDI_TXN_EXT_PROC_LOG file 1503.

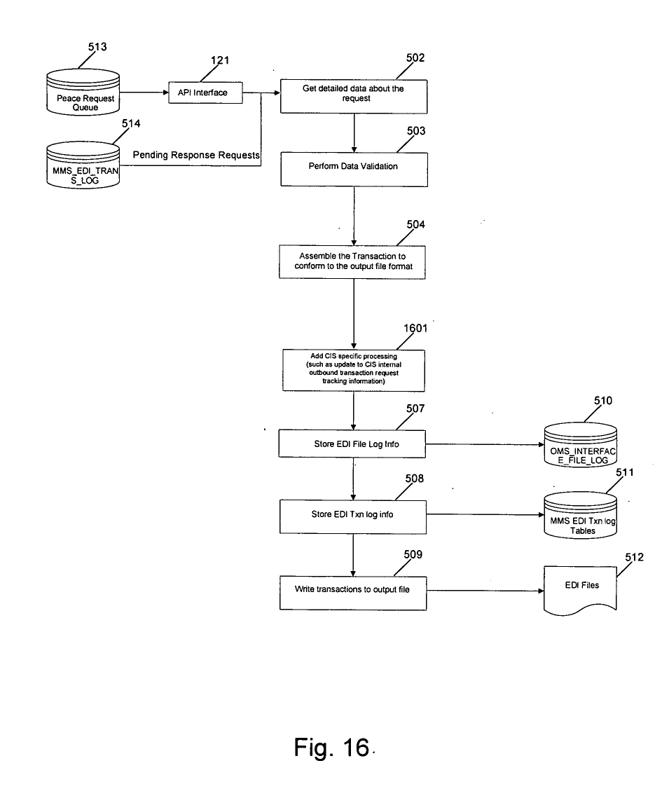

FIG. 16 is a data flow diagram illustrating assembling outbound enrollment and customer maintenance transactions (814). The 814 requests are generated thru various means—by Customer Service Representatives (CSRs) based on customer requests for new enrollments and customer changes or by batch processes (such as mass enrollments). Detailed data about a request is requested in block 502 from the Peace Request Queue 513 through the API interface 121. Requests from the Peace Request Queue 513 are converted into MMS Format by the API Interface 121. Additionally, pending response requests from the MMS_EDI_TRANS_LOG file 514 join these requests and combine with data from the billing system at block 502. Data validation is performed at block 503. Once validated, the transaction data is assembled to conform with the output file format in block 504. Then CIS specific processing takes place, such as updating the status of the CIS internal outbound transaction request tracking information in block 1601. The transaction's file information is logged in block 507 in the OMS_INTERFACE_FILE_LOG file 510. The transaction is logged in block 508 in the MMS EDI Txn log Tables 511. Finally, the transaction is written to an EDI output file 512 in block 509.

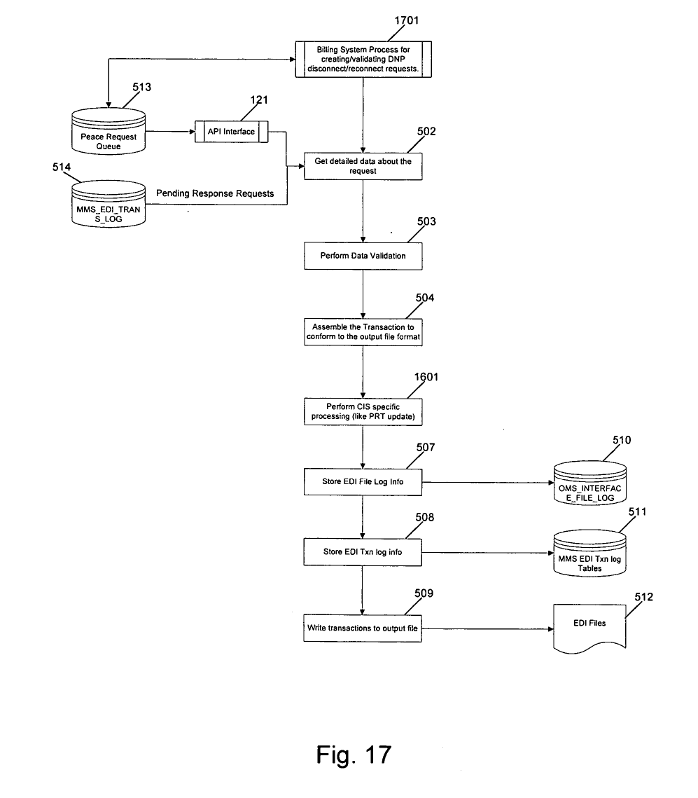

FIG. 17 is a data flow diagram illustrating outbound service order transactions such as disconnect/reconnect requests according to one embodiment. A transaction is created by a billing system process 1701 for creating/validating Disconnection for Non-Payment (DNP) disconnect/reconnect requests, which bi-directionally interacts with the Peace Request Queue 513. Requests from the Peace Request Queue 513 are converted into MMS Format by the API Interface 121. Additionally, pending requests from the MMS_EDI_TRANS_LOG file 514 join these requests and combine with data from the billing system at the block 502 which gets detailed. Data validation is performed at block 503. Once validated, the transaction data is assembled to conform with the output file format in block 504. Then CIS specific processing (such as PRT updates) takes place in block 1601. The transaction's file information is then stored in block 507 in the OMS_INTERFACE_FILE_LOG file 510. The transaction is logged in block 508 in the MMS EDI Txn log Tables 511. Finally, the transaction is written to an EDI output file 512 in block 509.

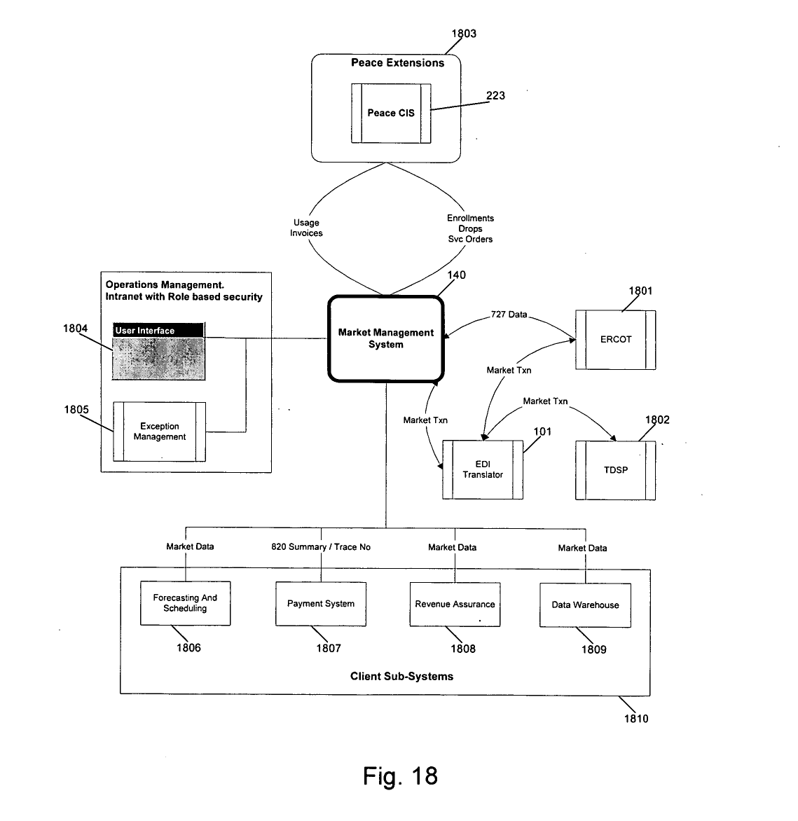

FIG. 18 is a block diagram illustrating system interfaces according to one embodiment. The Peace CIS application 223 is shown interfacing with the market management system 140 through its Peace extensions 1803. Usage invoices, enrollments, drops, and service orders pass between the market management system 140 and the Peace application 223. The market management system 140 may be accessed through a user interface 1804 and exceptions may be handled through an Exception Management system 1805. ERCOT 727 data moves bi-directionally between ERCOT module 1801 and the market management system 140. Market transactions move bi-directionally between TDSP module 1802 and the EDI translator module 101 and also between ERCOT module 1801 and the EDI translator module 101, which communicates with the market management system 140. From the market management system 140, market data and summary information is sent to client sub-systems 1810. Client subsystems 1810 comprise a series of modules for Forecasting and Scheduling 1806, Payment Systems 1807, Revenue Assurance 1808, and Data Warehousing 1809.

Although Peace (Energy) is the CIS in one embodiment, Peace is illustrative and exemplary only, and the architecture disclosed herein can support integration with other Utility CIS Applications. Although described in terms of the Texas ERCOT herein, ERCOT is illustrative and exemplary only and the architecture disclosed herein can support Transaction processing for Markets other than Texas.

The disclosed embodiments would allow a company using the Market Management System to consolidate its myriad Market Management solutions onto one common platform architecture. This consolidation will improve the company's ability to deliver cost effective transactions to its current set of customers and allow the company to expand its Market Management presence within the Utility Industry.

Functionality Options of the Market Management System Include:

Work Management—When errors and exceptions occur, business processes usually break down. Market Management automatically manages the vast majority of exceptions, but when human interaction is required, the exception is delivered to the right person, as quickly as possible, for correction and reentry to the ongoing business process. The Market Management System's online interface can be Web-based, easy to use, and explains the reason for the exception in clear language—allowing faster and easier resolution.

Browser User Interface—An online interface can be provided to review processing events, exceptions and transactions online

Reports Management System—Both standard and customized reports can be scheduled, viewed, and executed online.

Market Required Data and Message Exchange Certification services—Management of the process of certification in the market a client is pursuing can be accurate and timely.

Reporting—All mandatory Market or Regulatory Reports can be provided as required.

Market Currency—Professionals can participate in Market advisory groups to access proposed market changes and provide impact assessments to clients.

Translator services—provide conversion from EDI Formats from or to transactional data in formats appropriate to client needs and transaction validation against Market guidelines for format and valid values. Supporting infrastructure applications can include communications services for North American Energy Standards Board (NAESB) and FTP, EDI Translation, File and Transaction movement, and reconciliation both internally and with trading partners.

Configuration services—A company using the MMS can provide a turnkey integration with the client's CIS to meet the client's business drivers.

Although three levels are described below, any number of levels can be provided. The names Bronze, Silver and Gold are illustrative and exemplary only as are the specific features allocated to each service level.

In one embodiment, multiple levels of service can be provided as follows:

| Service Provided | Bronze | Silver | Gold |
|---|---|---|---|
| Work Management | | X | X |
| Exception Processing Resources | | | X |
| Browser User Interface | X | X | X |
| Reports Management | X | X | X |
| Market Certification Services | X | X | X |
| Market Currency | | | X |
| Market Advocacy | | | X |
| Translator | X | X | X |

Gold Description

The Management Solution consists of the batch transaction management system providing business process based processing rules, transaction validation against an underlying database of customer & meter reference data, exception management to ensure all market issues are resolved on behalf of the client, and the ability to provide or receive transactional data in formats appropriate to the UDC or EDC's needs. This level of service also includes assurance of market currency and advocacy. This solution is delivered through a common browser user interface with secure sign on and accessible from anywhere.

Silver Description

The Management Solution consists of the batch transaction management system providing business process based processing rules, transaction validation against an underlying database of customer & meter reference data, and the ability to provide or receive transactional data in formats appropriate to the UDC or EDC's needs. This is delivered through a common browser user interface with secure sign on and accessible from anywhere.

Bronze Description

The Translation Only application provides conversion from EDI Formats from or to transactional data in formats appropriate to the client's needs and transaction validation against Market guidelines for format and valid values. Supporting infrastructure applications include communications services for NAESB and FTP, EDI Translation, File and Transaction movement and reconciliation both internally and with trading partners.

The market management system is a business process and workflow engine that connects work requests, acknowledgement and fulfillment with the client's suppliers and their customers.

Market Entry Management: The various embodiments allow a company to take responsibility for the complete transition into the competitive market. This includes integration with the client's CIS, certification testing with all of the client's trading partners and market activation.

Exception Automation. The Market Management System fully automates most ongoing business transactions, dramatically reducing the number of errors and exceptions that must be handled manually or incremental systems investments.

Business Rules. The Market Management System uses business rules to intelligently tailor information to the specific requirements of its client and their trading partners. The result is process-ready information flows between internal and external application systems and the integration of people into interactive processes.

Intelligent Routing. When errors and exceptions occur, business processes usually break down. The Market Management System automatically manages the vast majority of exceptions, but, when human interaction is required, the exception is delivered to the right person, as quickly as possible, for correction and reentry to the ongoing business process. The Market. Management System's online interface can be Web-based, easy to use, and explains the reason for the exception in clear language—permitting faster and easier resolution.

Process Oversight. The Market Management System monitors business processes and transactions as part of an integrated process flow for the organization. Using this methodology, Market Management manages disparate transactions as a part of business events that correspond with and feed the integrated process flow. This approach ensures the business process is completed successfully and when exceptions do occur, they are handled without an impact on client resources.

The Market Management System solution enables the client to visualize how effectively it and its trading partners are performing through the automated communication of work requests, acknowledgement and fulfillment status. This solution improves the client's ability to monitor the transaction lifecycle, leading to quicker resolution of problems with a thorough root cause analysis leading to reduced exceptions.

The transaction data including account maintenance, move in, move out, meter readings, switching, terminations, service orders, history requests, TDSP payables are typically owned by the client. Statistical information around customer transaction frequency, migration, and switching, accuracy of information can be contracts are owned by the Market Management provider.

Timeliness of service order requests, fulfillment of activations, terminations, accuracy and timeliness of meter readings, accuracy and timeliness of TDSP charges can be owned by the Market Management provider.

The Market Management System translates into higher customer satisfaction because the client can now tell the status of customer requests, improved relationships with trading partners through the elimination of future problems, and minimization of scheduling delays because communication issues get resolved in real time.

Note: While this application generally discusses electric markets because of the centralized clearing of transactions, the MMS can also be used for deregulated gas markets and other kinds of markets.

The market management system as disclosed herein, is scalable and can include the full spectrum of capabilities and functionality described in this application or can be implemented in a phased approach to meet the client's specific business needs as they change over time. The system is CIS independent and also market independent. The market maps are universal for all currently opened markets so new market implementation is minimal. The configuration of client and market rules can be table driven, which can reduce the implementation time for new clients and new markets and allows changes made for one client to be available for all clients. The MMS can include multiple service levels as described above. These options allow the largest amount of choice for the client while still providing a common upgrade path from a lower level package (a translation and transportation only service) to an upper package (full service offering).

The Silver solution can be hosted model where the client manages the market with its own personnel through a secure browser user interface including exception processing, updates of rules, and market changes.

The Gold solution can be a full Business Process Outsourcing (BPO) model where the provider's resources manage all aspects of the client's market management activities including the full life cycle of transactions, market advocacy and market currency.

The Market Management System is tightly integrated with the CIS. There main benefits of tight integration include: 1) Perfect Data Synchronization—tight integration means that no duplication of customer records are necessary, which eliminates synchronization problems that can exist with a solution that is decoupled from the CIS; and 2) Less infrastructure to support the solution—since there is not a need to carry the extra load of CIS data within the Market Management database, reduced infrastructure results in significantly less DASD.

Rules Management. In a deregulated energy environment—where market success is contingent on the effective communication and processing of data among multiple industry participants—accuracy, timeliness, and reliability are important. The rapidly growing number of new industry participants further exacerbates the challenges of multicompany integration. This is even more important as energy companies expand their presence and reach into new market areas—the MMS eliminates the need for an intimate knowledge of the physical and logical attributes of an industry partner's information assets.

A Configurable Rules Superset (RS) of the MMS is a powerful feature of the MMS. RS amplifies the value of the MMS by facilitating transaction validation (syntactically and semantically—EDI systems can only provide syntactical error checking), sequencing, and intelligent routing. The MMS allows for the “splitting” and redirection of transactions to multiple recipients based on rules established with the RS. For example, a metering transaction can be forwarded and processed by an intercompany settlement system (used by the ESP and UDC), while it is simultaneously used to communicate energy consumption into the ESP's Accounts Receivable and Customer Relationship Management (CRM) applications. Intelligent routing becomes a progressively important feature as the population of business partners and business systems increase.

The MMS also maintains a complete history of all transactions. Every transaction communicated through the MMS can be stored in a data warehouse and date and time-stamped. Transactions can be tracked by a variety of attributes including type, business event, date, sender, receiver, and status. Additionally, unique control or trace numbers can be assigned to each transaction to ensure uniqueness and normalization. ESPs and UDCs can also apply their own control or trace numbers to facilitate tracking via their information systems.

Simple EDI-based solutions cannot comprehend the multitude of business, market, and regulatory rules that must be considered in the successful interaction between and process integration of trading partners. Therefore, the various embodiments have an integrated and robust rules engine as a cornerstone element of the MMS solution.

RS is a comprehensive facility designed to support the authoring, maintenance, and application of market, business, and data integrity rules specific to ESP and UDC entities. Numerous studies have shown that most data problems result from misunderstood data content, file formats, and communication schedules. Studies specific to newly deregulated energy markets have shown error and exception rates can approach 30%. However, the MMS is designed to reduce the error rate to less than ¼ of 1%. The RS minimizes these problems through its continuous application in the routing of transactions, transformation of data, and validation of information. On the rare occasion when errors occur, the system routes the issue back to the entity that created the error. This action enables the entity to identify and solve problems at the root cause level so that these errors are not repeated and do not corrupt the target partner.

All transactions passing through the MMS are logged and analyzed—market and business rules are applied to test transaction integrity and sequencing. Every piece of data is evaluated via these rules and automatically checked for accuracy. These automated checks and balances are used to prevent data exceptions and/or correct information problems as they occur. The result is significantly reduced error/exception handling and expense for ESPs and UDCs. Moreover, the codification and application of the client's business rules, coupled with market specific rules, enables the client to manage more trade and customer relationships with fewer staff and information resources.

Likewise, the “life” of a transaction is tracked and recorded through its history. Tracking can help minimize the effort required to correct and reinitiate errant transactions. In many cases, rules maintained within the RS are applied to suspend the transaction while automatic corrections are applied. Once the transaction has been successfully repaired and released, processing continues from the point of failure, not the transaction's origin. Thus, overall processing cycle time is significantly reduced—even in the case of problematic transactions.

The RS can also be used to ensure the proper sequencing of transactions between entities. Distinctions in transaction processing and timing between different industry participants are comprehended in various embodiments. Entity specific business rules can be applied to ensure that transaction recipients receive information in the order, with the content and accuracy required for seamless processing by their back-office systems.

The MMS allows for the introduction of transactions and requests through a variety of interfaces. These include batch, real-time, and user-initiated online queries. Flat files (e.g., delimited or fixed length), EDI transactions, or XML messages can all be used as vehicles to introduce transactions into the MMS. Industry standard security protocols are leveraged in the transmission of all data and transactions.

Reliability, sustainability, and security are crucial qualities in the transport of transactions between business entities. Performance may be increased while reducing risk if the provider operates its production systems in one city while maintaining a disaster recovery site in another city.

Given the comprehensive warehousing and date/time-stamping of all transaction passing through the MMS, the MMS provider is well positioned to provide comprehensive online audit trails and reporting. Up-to-the-minute access to the audit and transaction histories is extremely valuable in the resolution of potential business disputes.

Finally, the MMS can be configured to comply with all Gas Industry Standards Board (GISB), Utility Industry Group (UIG), and Coalition for Uniform Business Rules (CUBR) standards.

The MMS provides a comprehensive framework supporting online inquiry and report generation. Information respective to market participants, market certification activity, market provider roles and relationships is readily available for inquiry and reporting. Customer data, e.g., selections, status, service addresses, etc., transactional information, e.g., status, sender, recipients, etc., and event notifications are also available for inquiry and reporting. In essence, all information warehoused in the MMS can be accessible, searchable, and reportable via a secured Web interface to authenticated client users.

In one embodiment, Peace API calls are implemented thru a Java Enterprise Java Bean (EJB) framework, housed by a Bea WebLogic Application Server. The backend database can be Oracle 9i. The market management user interface can be created using ASP.Net and is served by a Microsoft IIS web server. These implemented details are illustrative and exemplary only and other software and hardware can be used as disclosed.

The Rep-Of-Record (ROR) processor provides various methods for other processes to call into to get the service account. It is the responsibility of the calling processes to determine what method they are going to use and call the corresponding ROR method. The checks performed by the ROR processor could result in exactly one service account, multiple service accounts, or none. The ROR processor will return back proper messages to the caller. It is the responsibility of the caller to act on the results (like create exceptions and/or send reject response back to the market). Once the caller gets a single service account back, it should perform transaction specific validation (data value and referential validations). If a transaction fails the ROR check, a reject response is not sent to the market until the 727 data has been verified as well. If a transaction fails the ROR check, but passes the 727 data validation, then an exception is created and a reject response is not sent to the market automatically. This transaction is not sent to Peace for processing. If a transaction fails 727 validation, but passes the ROR check, then an exception is created, and the transaction is still presented to Peace for processing.

The foregoing disclosure and description of the invention are illustrative and explanatory thereof, and various changes in the details of the illustrated apparatus and construction and the method of operation may be made without departing from the spirit of the invention.

We claim:

1. A system for managing transactions between a first party and a customer information system (CIS) for a second party comprising:
an interface adapted to process transactions from the first party in a first format;
a transaction processor, comprising:
an inbound component, comprising:
a validation subsystem adapted to validate the transactions according to a predetermined set of business rules, using the CIS for transaction storage;
an outbound component adapted to send transaction data to the first party;
a data loader, comprising:
a first component adapted to send the transactions in a second format to the CIS; and
a second component adapted to receive responses from the CIS in the second format; and
a data format converter, adapted to convert the transactions and the responses between the first format and the second format.

2. The system of claim 1, the inbound component further comprising:
a tracking subsystem adapted to track the transaction statistical data, comprising:
a transaction tracking statistics database.

3. The system of claim 1, wherein the transactions are electrical energy industry commercial transactions complying with an electrical energy industry standard.

4. The system of claim 1, wherein the transactions comprise electronic invoices.

5. The system of claim 1, wherein the transactions comprise receiving reports.

6. The system of claim 1, wherein the responses indicate rejection of the transactions.

7. The system of claim 1, wherein the outbound component is operable to log transaction data sent to the first party.

8. The system of claim 7, further comprising a database,
wherein the outbound transaction processor is adapted to transmit transaction log data to the database.

9. A method for managing transactions comprising:
loading transaction data in a first format from a first party;
validating the transaction data against a set of predetermined business rules, comprising:
bi-directionally communicating with a customer information system (CIS) without storing transaction data in a validation database;
recording tracking information about the transaction data;
converting the transaction data into a second format;
sending the transaction data in the second format to the CIS;
generating a report based on the validation of the transaction data;
converting a response from the CIS in the second format to the first format; and
sending outbound transaction data corresponding to the response in the first format.

10. The method of claim 9, further comprising:
tracking the transaction data in a tracking database.

11. The method of claim 9, wherein the transaction data relates to electrical energy industry transactions.

12. The method of claim 9, wherein the set of predetermined business rules are determined by the CIS.

13. The method of claim 9, wherein the report based on the validation of the transaction data from the CIS comprises a set of market reject transactions.

14. The method of claim 9, the outbound transaction data comprising:
service delivery point information; and
service orders.

15. A system for managing electronic data interchange (EDI) transactions between a first party and a customer information system (CIS) for a second party, comprising:
an EDI translator, configured to translate EDI transactions between a first format and a second format, wherein the first party receives and transmits the EDI transactions in the first format;
a market management system, comprising:
an inbound transaction processor, operable to process EDI transactions from the first party in the second format;
a CIS application programming interface (API), configured for bi-directional communication with the CIS; and
an outbound transaction processor, operable to process EDI transactions to the first party in the second format,
wherein the inbound transaction processor and the outbound transaction processor store transaction data in the CIS using the API while processing the EDI transactions instead of a market management system database.

16. The system of claim 15, the API comprising:
a first API, independent of the CIS; and
a adaptor API dependent on the CIS, in bidirectional communication with the first API and the CIS,
whereby the market management system is configurable for use with a different CIS by changing only the adaptor API.

17. The system of claim 15, the inbound transaction processor comprising:
a validation subsystem, operable to validate the EDI transactions and to generate outbound transactions for the outbound transaction processor if validation is unsuccessful.

18. The system of claim 15, the inbound transaction processor comprising:
a transaction statistics subsystem operable to track the EDI transactions processed by the inbound transaction processor and to create and maintain transaction statistics.

19. The system of claim 15, the inbound transaction processor comprising:
a reporting subsystem.

20. The system of claim 15, the inbound transaction processor comprising:
an integrated rules engine configured to process the EDI transactions according to a predetermined set of business rules.

21. The system of claim 15, the inbound transaction processor comprising:
an automated exception management subsystem.

22. The system of claim 15, the inbound transaction processor operable to perform retail electricity provider of record processing.

23. The system of claim 15, the outbound transaction processor operable to generate EDI transactions to the first party responsive to data from the CIS.

24. The system of claim 15, the outbound transaction processor comprising:
an EDI transaction logging subsystem.

25. The system of claim 15, wherein the EDI transactions are electrical energy industry transactions according to an electrical energy industry standard.

26. The system of claim 15, wherein the CIS is selected by the second party independent of the first party.

27. A method of processing electronic data interchange (EDI) transactions between a first party and a customer information system (CIS) for a second party, comprising:
processing EDI transactions from the first party, comprising:
receiving EDI transactions from the first party in a first format;
translating EDI transactions from the first format to a second format; and
validating EDI transactions according to a predetermined set of business rules;
bi-directionally communicating EDI transaction data with the CIS;
processing EDI transactions to the first party, comprising:
translating EDI transactions from the second format into the first format;
transmitting EDI transactions to the first party,
wherein validating EDI transactions is performed without storing EDI transaction data in a validation database separate from the CIS.

28. The method of claim 27, wherein the EDI transactions are electrical energy industry transactions according to an electrical energy industry standard.

29. The method of claim 27, processing EDI transactions from the first party further comprising:
generating EDI transaction statistical data; and
storing the EDI transaction statistical data in a statistical database.

30. The method of claim 27, processing EDI transactions from the first party further comprising:
generating EDI transaction validation failure transactions;
transmitting the EDI transaction validation failure transactions to the first party.

31. The method of claim 27, bi-directionally communicating EDI transaction data with the CIS comprising:
communicating with a first application programming interface independent of the CIS;
communicating with a second application programming interface dependent on the CIS, the first application programming interface bi-directionally communicating with the second application programming interface.

32. The method of claim 27, the second format is selected independent of the first party and the second party.

33. The method of claim 27, further comprising:
reporting transactional statistical data.

34. The method of claim 27, wherein the predetermined set of business rules is defined by the second party.

35. The method of claim 27, processing EDI transactions to the first party further comprising:
logging EDI transactions transmitted to the first party.

36. The method of claim 27, wherein the second format is selected independent of the first party and the second party.

37. The method of claim 27, further comprising:
archiving EDI transaction data.
